(19) United States
(12) Patent Application Publication
(10) Pub. No.: US 2007/0269742 A1
(43) Pub. Date: Nov. 22, 2007

(54) OPTICAL INFORMATION RECORDING MEDIUM AND METHOD OF PRODUCING THE SAME

(76) Inventors: Takuo KODAIRA, Takasaki-shi (JP); Akio AMANO, Takasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/750,484

(22) Filed: May 18, 2007

(30) Foreign Application Priority Data
May 19, 2006 (JP) 2006-139888

(51) Int. Cl. G11B 7/24

(52) U.S. Cl. 430/270.2; 430/270.18; 430/945; 430/270.15; 369/284; 428/64.8

(57) ABSTRACT

An optical information recording medium includes an optical recording layer onto which information is to be recorded by a laser beam, wherein the optical recording layer includes a dye film containing a specific mono(aza)methine compound and an acid and is directly provided on a surface of a layer that allows transmittance of the laser beam therethrough, the surface being arranged opposite a surface of the layer through which the laser beam enters. The optical recording layer is formed by applying a solution of a mono(aza)methine dye composition containing the acid and the specific mono(aza)methine dye compound by a spin-coating method.

### BACKGROUND OF THE INVENTION

1. Field of the Invention

The present invention relates to an optical information recording medium and a method of producing the same. In particular, the present invention relates to an optical information recording medium that includes at least an optical recording layer containing a light-absorbing substance and the like, and that can be used for the optical recording layer of an optical information recording medium onto and from which writing and reproducing can be performed with a high density and at a high speed using a semiconductor laser that emits a red laser beam having a wavelength in the range of 750 to 830 nm, a short-wavelength red laser beam having a wavelength in the range of 640 to 680 nm (for example, 650 to 665 nm), or a blue laser beam having a shorter wavelength in the range of about 350 to 500 nm (for example, about 405 nm), and a method of producing the optical information recording medium.

2. Description of the Related Art

Write-once optical recording discs such as CD-R discs, which were developed first, and DVD-R/+R discs, which are discs having a format for large-capacity recording and were subsequently developed, include a dye thin-film used as a recording layer. This dye is decomposed by high-power laser beam irradiation to change an optical property of the film, thereby performing recording. More specifically, in unrecorded portions, signal light having a high ratio of the intensity of light irradiated by a laser for reproducing and return light from a reflective film which interfere with each other to the intensity of the irradiated light (i.e., reflectance) is detected. On the other hand, in recorded portions, the reflectance is decreased because the refractive index of the dye is decreased by the decomposition of the dye. The weakened reflected light is detected as recording signals. Such a recording principle is generally referred to as “high-to-low recording”. This indicates that a reflectance, which is high before recording, is decreased after recording, thereby enabling signals to be recorded. In order to record information in this manner, the refractive index of a dye thin-film used as a recording layer is important.

Hitherto, as examples of CD-R discs onto and from which recording and reproducing are performed with a laser beam having a wavelength of 780 nm, and DVD-R/+R discs onto and from which recording and reproducing are performed with a laser beam having a wavelength of 660 nm, many high-to-low recording-type write-once optical recording discs based on the above principle have arrived on the market. However, among the HD DVD-R discs and the Blu-ray Disc-R discs (hereinafter, these are also referred to as “blue discs” or the like) onto and from which recording and reproducing are performed with a laser beam having a wavelength of 405 nm, high-to-low recording commercial products having satisfactory practicability have not yet been developed. This is because a dye thin-film having a proper refractive index has not been obtained.

As shown in FIG. 1, an HD DVD-R (write-once HD DVD) disc 1 includes a light-transmissive substrate 2 serving as a layer that allows transmittance of a laser beam therethrough, an optical recording layer 3 (light-absorbing layer) provided on the substrate 2, a light-reflecting layer 4 provided on the optical recording layer 3, and a protective layer 5 (adhesion layer) provided on the light-reflecting layer 4. The substrate 2 is made of a highly transparent material having a refractive index for a laser beam in the range of, for example, about 1.5 to 1.7 and excellent impact resistance. Examples of the substrate 2 include resin plates such as a polycarbonate plate, an acrylic plate, and an epoxy plate; and glass plates. The light-reflecting layer 4 is a metal film having a high thermal conductivity and a high light reflectivity. The light-reflecting layer 4 is formed by depositing, for example, gold, silver, copper, aluminum, or an alloy thereof by vapor deposition, sputtering, or other processes as known by one of ordinary skill. The protective layer 5 is made of a resin having an impact resistance as high as that of the substrate 2 and excellent adhesiveness. For example, the protective layer 5 is formed by applying a UV curable resin by spin coating and then curing the resin by irradiating ultraviolet rays. Furthermore, a dummy substrate 6 that has a predetermined thickness of about 1.2 mm and that is made of the same material as the substrate 2 is laminated on the protective layer 5 as required so that the HD DVD-R disc 1 has a predetermined thickness specified as a standard.

A spiral pregroove 7 is provided on the substrate 2. Lands 8, i.e., portions other than the pregroove 7, are disposed at both sides of the pregroove 7.

The optical recording layer 3 provided on the substrate 2 is composed of a light-absorbing substance containing a dye material. When the optical recording layer 3 is irradiated with a laser beam 9, heat generation, heat absorption, melting, sublimation, deformation, or modification occurs in the optical recording layer 3. This optical recording layer 3 is formed by, for example, dissolving an azo dye, a cyanine dye, or the like in a solvent, and then uniformly coating the resulting solution on the surface of the substrate 2 by spin coating or the like.

Any optical recording material can be used for the optical recording layer 3, but a light-absorbing organic dye is preferred.

As shown in FIG. 1, when the HD DVD-R disc 1 is irradiated with the laser beam 9 (recording light) from the side of the light-transmissive substrate 2 (incident layer), the optical recording layer 3 absorbs energy of the laser beam 9, thus generating (or absorbing) heat. Consequently, a recording pit 10 is formed by thermal decomposition of the optical recording layer 3. Reference numerals 11, 12, 13, and 14 in FIG. 1 each indicate a boundary of adjacent layers.

As shown in FIG. 2, a Blu-ray Disc-R (write-once Blu-ray) disc 20 includes a light-transmissive substrate 2 having a thickness of 1.1 mm, a light-reflecting layer 4 provided on the substrate 2, an optical recording layer 3 (light-absorbing layer) provided on the light-reflecting layer 4, a protective layer 5 provided on the optical recording layer 3, an adhesion layer 21 provided on the protective layer 5, and a cover layer 22 having a thickness of 0.1 mm and provided on the adhesion layer 21. Recently, the cover layer 22 is often provided on the protective layer 5 without forming the adhesion layer 21 so that the protective layer 5 also functions as an adhesion layer.

A spiral pregroove 7 is provided on the substrate 2. Lands 8, i.e., portions other than the pregroove 7, are disposed at both sides of the pregroove 7.

When the boundary between the substrate 2 and the optical recording layer 3 satisfies a low reflectance, the light-reflecting layer 4 need not be provided.

As shown in FIG. 2, when the Blu-ray Disc-R disc 20 is irradiated with a laser beam 9 (recording light) from the side of the light-transmissive incident layer (cover layer 22) serving as a layer that allows transmittance of the laser beam therethrough, the optical recording layer 3 absorbs energy of the laser beam 9, thus generating (or absorbing) heat. Consequently, a recording pit 10 is formed by thermal decomposition of the optical recording layer 3. Reference numerals 23, 24, 25, 26, and 27 in FIG. 2 each indicate a boundary of adjacent layers. In the figure, the recording pit is formed on the optical recording layer 3 on the land 8. Alternatively, recently, the recording pit is often formed on the optical recording layer 3 on the pregroove 7.

In high-speed recording on the HD DVD-R disc 1 or the Blu-ray Disc-R disc 20 having the above structure, it is necessary to perform predetermined recording within a time shorter than a typical recording speed or a low-speed recording. Therefore, a recording power is increased, thereby increasing the quantity of heat generated in the optical recording layer 3 and the quantity of heat per unit time during recording. Consequently, a problem of thermal strain easily occurs, resulting in variations among the recording pits 10. In addition, the output power of a semiconductor laser for emitting the laser beam 9 is limited. Accordingly, a highly sensitive dye material that can be used for high-speed recording has been desired.

In the known write-once optical information recording media such as CD-R and DVD-R discs, a great importance is placed on the formation of a recording pit by changing the refractive index by decomposition and denaturation of an organic compound used for an optical recording layer, and it is important to select a material that has an appropriate optical constant and that exhibits an appropriate decomposition behavior. However, in such an organic compound, optical properties (in particular, refractive index) for a blue laser wavelength, e.g., 405 nm are normally mediocre. The reason for this is as follows. In order that an organic compound has a laser beam absorption band in the vicinity of the blue laser wavelength, as regards a cyanine dye having a methine chain, it is necessary to decrease the length of the molecular skeleton or decrease the length of the conjugated system. However, in this case, the absorption coefficient, that is, the refractive index, is decreased, and therefore, a high degree of modulation cannot be achieved during reproducing.

The term “highly sensitive dye material” means that the dye has an appropriate refractive index. In order to achieve this, the refractive index (n) must be high and the extinction coefficient (k) must be low. It is known that, to achieve this, the dye must have a high absorptivity and the full width at half maximum of the absorption spectrum must be small.

It is generally known that as the maximum absorption wavelength (λₘₐₓ) is decreased, the molar absorptivity (ε) is decreased, and that it is difficult to develop a dye that can be used to realize high-to-low-type optical recording discs for a short recording wavelength, which is used for the blue discs or the like.

There are some dyes that can be practically used for low-to-high-type recording, which has a recording property inverse to that of high-to-low-type recording. However, in high-speed recording, the calorific value due to the decomposition of a dye is high. Therefore, high-quality recording cannot be performed because of thermal interference resulting in the recording pits becoming enlarged. Accordingly, a dye whose calorific value during its decomposition is low has been desired.

As described above, an optical information recording medium has also been developed onto and from which recording and reproducing can be performed using a blue laser beam having a wavelength in the range of about 350 to 500 nm (e.g., about 405 nm), which is shorter than the wavelength of a commonly used laser beam. Regarding an organic dye compound used for an optical recording layer, as the wavelength of the laser beam is decreased, it is necessary to form a thin film serving as the optical recording layer and to obtain a high refractive index. In order to achieve the high refractive index, the dye must have a high absorptivity, and the full width at half maximum of the absorption spectrum must be small.

As described above, there are few materials having a high molar absorptivity (ε) for a blue laser beam. Accordingly, in order to increase the refractive index of the optical recording layer 3, it is important to control the full width at half maximum, which relates to the degree of aggregation of dye molecules when a dye film is formed.

FIG. 3 shows the relationship between the full width at half maximum (full width at half maximum (degree of aggregation)/cm⁻¹) of an absorption spectrum and the refractive index (n max). A material having a high refractive index can be ensured by using a material that shows an appropriate full width at half maximum.

From this point of view, the use of an aggregation state, in particular, the J-aggregation, of dye molecules has been studied. In the state of the J-aggregation, dye molecules are arrayed in an edge-to-edge manner. It is known that when this J-aggregation occurs, a peak of an optical absorption spectrum becomes sharper, the full width at half maximum of the peak is decreased, and the peak is shifted to the long-wavelength side.

Known technologies for forming a thin film containing a J-aggregate (hereinafter also referred to as “J-aggregate thin film”) include a Langmuir-Blodgett (LB) method, a dip method, and a spin-coating method.

In the Langmuir-Blodgett (LB) method, when molecules having both a hydrophilic group and a hydrophobic group are dissolved in a proper solvent and the solution is then spread on the water surface, the molecules are adsorbed on the gas-liquid interface to form a monomolecular film on the water surface. When a substrate or the like is gradually immersed therein, a uniform thin film can be formed. A precise and uniform thin film can be formed by this LB method to produce a thin film having excellent optical properties. However, since skilled control is necessary during the formation of the film, this method is disadvantageous in terms of time and cost.

In the dip method, a substrate is immersed in a dye solution, then pulled out from the solution, and dried, thereby forming a dye film on the surface of the substrate. In the dip method, aggregation can be easily controlled. However, the dip method is disadvantageous in that it is difficult to form a uniform thin film and stably maintain the thin film.

In the spin-coating method, a solution is applied dropwise on a substrate while the substrate is rotated, and the solution is spread by the centrifugal force. A thin film can be relatively easily formed by the spin-coating method. However, since molecules are present in various states under a simple coating condition, it is difficult to control the aggregation. This spin-coating method is superior to the other methods in view of simplicity and ease of the process, and is widely employed in the process for producing optical information recording media such as CD-R and DVD-R discs.

Examples of J-aggregate thin films prepared by the spin-coating method or a similar method of forming a thin film include the following.

Japanese Unexamined Patent Application Publication No. 2000-199919 discloses a method of forming a thin film containing a J-aggregate of an organic dye (cyanine dye). More specifically, a J-aggregate thin film is formed using a sol solution containing a cyanine dye and silica.

In this technique, satisfactory dye physical properties as a dye thin film used for an optical information recording medium cannot be obtained because the concentration of the cyanine dye in the thin film is decreased by the silica. Therefore, the dye thin film is not suitable for use in an optical information recording medium. That is, it is difficult to apply this technique to an optical information recording medium.

Japanese Unexamined Patent Application Publication No. 2001-151904 discloses a method of forming a thin film containing a J-aggregate of an organic dye (cyanine dye). More specifically, a high-viscosity solution containing a cyanine dye and a polymer material is subjected to a rubbing treatment to prepare a J-aggregate thin film.

In this technique, satisfactory dye physical properties as a dye thin film used for an optical information recording medium cannot be obtained because the concentration of the cyanine dye in the thin film is decreased by the polymer material. Therefore, the dye thin film is not suitable for use in an optical information recording medium. Furthermore, when heat (temperature: 130° C.) required for the rubbing treatment is applied to the substrate 2 made of a polycarbonate resin, the shape of the substrate 2 is changed. That is, it is difficult to apply this technique to an optical information recording medium.

Japanese Unexamined Patent Application Publication No. 2001-305591 discloses a method of forming a thin film containing a J-aggregate of an organic dye (squarylium dye). More specifically, a J-aggregate thin film is formed by applying a solution containing a squarylium dye, which is easily formed into a J-aggregate thin film, by a spin-coating method.

The technique disclosed in this patent document is disadvantages in that the squarylium dye has a poor solubility in organic solvents. Accordingly, it is difficult to ensure the solubility in a solvent that does not corrode the polycarbonate resin, which is a material of the substrate 2 of the optical information recording medium. That is, it is difficult to obtain a sufficient thickness required for a dye thin film used for an optical information recording medium. When the squarylium dye molecules are chemically modified with an appropriate substituent in order to ensure the solubility, this chemical modification affects the formation of the J-aggregate thin film. Accordingly, the design of the squarylium dye molecules is complex because both the solubility and the degree of aggregation of the molecules must be considered. That is, it is difficult to apply this technique to an optical information recording medium.

According to Japanese Patent No. 3429521, an LB film is used as a material of the optical recording layer 3. More specifically, a substrate 2 having a dye film containing a photochromic dye is used, and this substrate 2 is a ceramic substrate that radiates far-infrared rays. This patent document discloses an optical information recording medium in which the above photochromic material is an aggregate of molecules of a dye and the dye film is a spiropyran J-aggregate thin film. A chloroform solution prepared by mixing different types of cyanine dyes and a specific fatty acid in an appropriate mixing ratio is spread on a water surface and compressed to form a monomolecular film in which the molecular orientation is controlled. This film is formed on the substrate 2 and used as the dye film containing the photochromic dye.

In this technique, a substrate is prepared by performing a hydrophobic treatment on the surface of a non-fluorescent glass substrate using trimethylchlorosilane. The above molecular-orientation-controlled monomolecular films are adsorbed on the substrate by a vertical immersion method so that 20 layers are accumulated on one side of the substrate. However, it is difficult to obtain a sufficient thickness required for a dye thin film used for an optical information recording medium. In addition, it is very difficult to apply the LB method to the current optical information recording medium.

J-aggregate thin films can have a high refractive index and are useful for the optical recording layer 3 of the HD DVD-R disc 1 and the Blu-ray Disc-R disc 20. However, at present, a simple preparation method in which aggregation can be easily controlled has not yet been established. The J-aggregate thin films can be relatively easily prepared by the LB method or the dip method, but these methods are disadvantageous in that skilled control is necessary or a uniform thin film cannot be stably obtained. On the other hand, although thin films can be easily formed by the spin-coating method, it is difficult to prepare J-aggregate thin films by the spin-coating method.

### SUMMARY OF THE INVENTION

At lest one embodiment of the present invention has been conceived in view of the above problems, and an object of at least one embodiment of the present invention is to provide an optical information recording medium in which optical properties can be improved by directly forming a J-aggregate of a mono(aza)methine dye compound that can provide a uniform thin film containing a J-aggregate of dye molecules without forming other auxiliary layers, and a method of producing the same.

An object of at least one embodiment of the present invention is to provide an optical information recording medium in which a thin film having a high refractive index (e.g., 1.7 to 2.8) and satisfactory optical properties can be formed, and a method of producing the same.

An object of at least one embodiment of the present invention is to provide an optical information recording medium in which an optical recording layer containing a J-aggregate can be formed by a simple method (spin-coating method), and a method of producing the same.

An object of at least one embodiment of the present invention is to provide an optical information recording medium in which a dye material can be applied using a solvent that does not corrode a substrate material, such as a polycarbonate resin, and a method of producing the same.

An object of at least one embodiment of the present invention is to provide an optical information recording medium in which a component in a thin film of the optical recording layer is mainly composed of a dye material, which is suitable for high-speed high-density recording, and which has a high sensitivity and an excellent short-mark recording ability, and a method of producing the same.

As a result of intensive studies, the present inventors have found the following. In the known CD-R and DVD-R/+R discs, an amorphous thin film of dye molecules is used, and the dye molecules are randomly oriented in the thin film. In the thin film in which the molecules are randomly oriented, intermolecular interaction is weak and the thin film shows a broad absorption spectrum. In contrast, in a J-aggregate, molecules form a minute molecular aggregate while being regularly arrayed by intermolecular interaction. Therefore, the absorption spectrum has a small full width at half maximum, and the absorbance is larger than that in the case where molecules are randomly oriented. Accordingly, by preparing a J-aggregate thin film, a dye thin film having a high refractive index (n) and a low extinction coefficient (k) can be formed. Accordingly, it is expected that a high-to-low optical information recording medium can be realized. Furthermore, when recording is performed by breaking an aggregate by irradiation of a recording laser beam, the quantity of heat generated by the decomposition can be decreased and thermal interference can be suppressed.

Such a J-aggregate has been known for a long time. As described above, such a J-aggregate has been formed in a solution with a high concentration, and a J-aggregate thin film has been formed by a method of allowing molecules to be forcibly oriented, e.g., a method of preparing an LB film. As described above, such a method is disadvantageous in terms of time and cost. Therefore, the J-aggregate cannot be used for optical recording discs for practical use. However, recently, for example, by substituting terminals of two N-alkyl chains of an indolenine cyanine dye with sulfonic acid groups, it has been possible to form a J-aggregate thin film by a spin-coating method (Japanese Unexamined Patent Application Publication No. 2005-74872 and Japanese Patent Application No. 2004-101442 (by the applicant of the present invention)). A J-aggregate thin film may have a thickness of about 30 nm to about 300 nm. At least one embodiment of the present invention focuses on the following points: A uniform thin film can be simply formed by a spin-coating method using other mono(aza)methine dye compounds; a satisfactory optical property (high refractive index) is achieved using a dye material that can form a J-aggregate; for example, oxazole nucleus- or thiazole nucleus-containing mono(aza)methine compounds (mono(aza)methine cyanines) having a satisfactory solubility are used as the above dye material so that a solvent that does not corrode a substrate can be used; and thus, dyes in which a large difference in the refractive index can be achieved before and after recording and which are decomposed by an endothermic reaction can be used.

At least one embodiment of the present invention provides an optical information recording medium including an optical recording layer onto which information is to be recorded by a laser beam, wherein the optical recording layer includes a dye film containing a mono(aza)methine compound represented by general formula [1] and an acid and is directly provided on a surface of a layer that allows transmittance of the laser beam therethrough, the surface being arranged opposite a surface of the layer through which the laser beam enters: 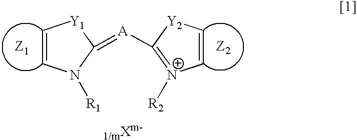
(wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may have a substituent; Y₁ and Y₂ each represent one selected from the group consisting of O, S, N—R (wherein R represents an alkyl group of (CH)ₙCH₃ (wherein n represents an integer selected from 0 to 5)), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; and 1 /m X^{m-} (wherein m represents an integer selected from 1 to 4) represents at least one anion selected from the group consisting of an organic anion, an inorganic anion, and an organometallic anion).

In an embodiment of the optical information recording medium, the mono(aza)methine compound represented by general formula [1] may be a compound represented by general formula [2]: 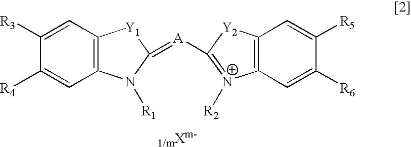
(wherein Y₁ and Y₂ each represent one selected from the group consisting of O, S, N—R (wherein R represents an alkyl group of (CH)ₙCH₃ (wherein n represents an integer selected from 0 to 5)), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; 1/m X^{m-} (wherein m represents an integer selected from 1 to 4) represents at least one anion selected from the group consisting of an organic anion, an inorganic anion, and an organometallic anion; and R₃ to R₆ each represent one selected from the group consisting of a hydrogen atom, a linear or branched aliphatic hydrocarbon group such as an alkyl group of (CH)ₙCH₃ (wherein n represents an integer selected from the group consisting of a hydrogen atom, a linear or branched aliphatic hydrocarbon group such as an alkyl group of (CH)ₙCH₃ (wherein n represents an integer selected from 0 to 5), a halogenated aliphatic hydrocarbon group such as a halogenated alkyl group, a halogen atom, an ether group such as an alkoxy group, an ester group, an alkylsulfamoyl group, a nitro group, a cyano group, an aromatic ring, and a heterocyclic ring, each of R₃ to R₆ may have a substituent, and R₃ to R₆ may be the same or different.)

In any of the foregoing embodiments of the optical information recording medium, the acid is preferably at least one of an organic acid and an inorganic acid such as hydrochloric acid, sulfuric acid, and nitric acid, and the molar ratio of the hydrogen ion (H⁺) in the acid to the mono(aza)methine dye compound represented by general formula [1] or [2] is preferably in the range of 0.8 to 3.5 (including 1, 2, 3, and values between any two numbers of the foregoing; 1.5 to 2.5 in another embodiment).

In any of the foregoing embodiment of the optical information recording medium, the dye film preferably contains a J-aggregate of the mono(aza)methine compound represented by general formula [1] or [2].

In any of the foregoing embodiment of the optical information recording medium, the laser beam may have a wavelength in the range of 350 to 500 nm.

At least one embodiment of the present invention also provides a method of producing an optical information recording medium including an optical recording layer onto which information is to be recorded by a laser beam, the method including applying a solution of a mono(aza)methine dye composition containing a mono(aza)methine dye compound represented by general formula [1] or [2] shown above and an acid by a spin-coating method to form the optical recording layer.

In an embodiment of the method of producing an optical information recording medium, the mono(aza)methine dye compound preferably forms a J-aggregate.

In any of the foregoing embodiments of the method of producing an optical information recording medium, a fluorinated alcohol such as 2,2,3,3-tetrafluoro-1-propanol is preferably used as a solvent for dissolving the mono(aza)methine dye compound. In an embodiment, the concentration of the mono(aza)methine dye compound may be in the range of about 5 to about 40 g/L.

The above-described mono(aza)methine dye compound, the composition containing this compound and an acid, the optical information recording medium including the composition, and the production method thereof can be applied not only to recording and reproducing using a blue laser beam but also to CD and DVD discs for recording and reproducing.

Methods of synthesizing the mono(aza)methine dye compound include, but are not limited to, a method of synthesizing an oxazole nucleus-containing mono(aza)methine compound (Japanese Unexamined Patent Application Publication No. 10-60295) and a method of synthesizing a compound containing a thiazole nucleus or a quinoline nucleus as a heterocyclic ring (Great Britain Patent No. 447,038). A method of synthesizing a monomethine cyanine compound is also described in PCT Publication No. WO 2005/095521A1 (PCT/JP2005/006724), and this method can be employed. An NMR analyzer, a GC/MS analyzer, and the like can be used to identify the molecular structure of mono(aza)methine cyanine compounds.

In the optical information recording medium according to at least one embodiment of the present invention and the method of producing the same, the optical recording layer includes a dye film containing a specific dye material of the mono(aza)methine compound represented by general formula [1] or [2] and an acid. Accordingly, a uniform thin film containing a J-aggregate of the dye molecules can be formed even by a simple spin-coating method. When the J-aggregation occurs, a peak in the absorption spectrum of the dye thin film becomes sharper, the full width at half maximum of the peak is decreased, and the peak is shifted to the long-wavelength side. Consequently, a thin film having a high refractive index can be formed. Accordingly, when the aggregated dye is thermally decomposed by light absorption derived from the J-aggregation of the dye molecules, a difference in the refractive index can be easily generated before and after recording. Furthermore, since this thermal decomposition of the J-aggregate of the dye is an endothermic reaction, control of heat dissipation, which is required in a known case of an exothermic reaction, need not be performed.

That is, a recording material thin film having excellent optical properties, such as a high refractive index and a large difference in the refractive index before and after recording, and a thermal property corresponding to an endothermic reaction, can be uniformly formed. Furthermore, the aggregate thin film is formed by a simple spin-coating method, and thus, an optical information recording medium having excellent properties can be produced without changing a known process.

Furthermore, by using a mono(aza)methine dye compound having a satisfactory solubility, the dye material can be applied on a substrate using a solvent such as 2,2,3,3-tetrafluoro-l-propanol (TFP) which does not corrode the substrate.

For purposes of summarizing the invention and the advantages achieved over the related art, certain objects and advantages of the invention are described in this disclosure. Of course, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

Further aspects, features and advantages of this invention will become apparent from the detailed description of the preferred embodiments which follow.

### BRIEF DESCRIPTION OF THE DRAWINGS

These and other features of this invention will now be described with reference to the drawings of preferred embodiments which are intended to illustrate and not to limit the invention. The drawings are oversimplified for illustrative purposes and are not to scale.

FIG. 1 is an enlarged cross-sectional view of the relevant part of a general disc-shaped optical information recording medium (HD DVD-R disc).

FIG. 2 is an enlarged cross-sectional view of the relevant part of another general disc-shaped optical information recording medium (Blu-ray Disc-R disc).

FIG. 3 is a graph showing the relationship between the full width at half maximum of an absorption spectrum and the refractive index.

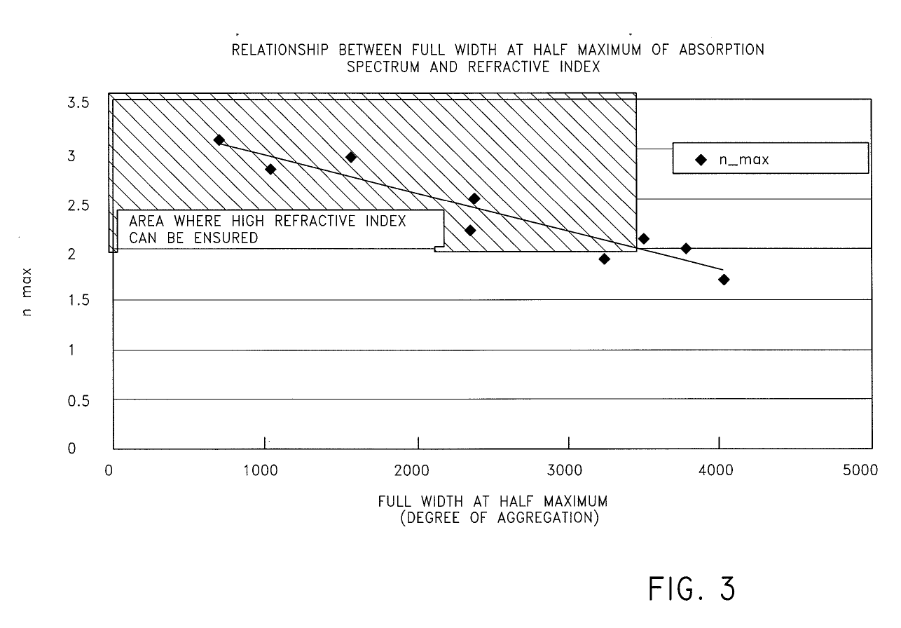

FIG. 4 is a graph showing the measurement results including spectra of a solution prepared by adding phosphoric acid to Compound I (formula [9]) and thin films each prepared by applying the solution or the like (on a single plate).

FIG. 5 is a graph showing the measurement results including spectra of thin films each prepared by applying a solution containing Compound X (formula [10]) and phosphoric acid (on a single plate).

FIG. 6 is a graph showing the measurement results including spectra of thin films each prepared by applying a solution containing Compound XI (formula [11]) and phosphoric acid (on a single plate).

FIG. 7 is a graph showing the measurement results including spectra of thin films each prepared by applying a solution containing Compound II (formula [12]) and phosphoric acid (on a single plate).

FIG. 8 is a graph showing the measurement results including spectra of thin films each prepared by applying a solution containing Compound III (formula [13]) and phosphoric acid (on a single plate).

FIG. 9 is a graph showing the measurement results including spectra of thin films each prepared by applying a solution containing Compound IV (formula [14]) and phosphoric acid (on a single plate).

FIG. 10 is a graph showing the measurement results including spectra of thin films each prepared by applying a solution containing Compound V (formula [15]) and phosphoric acid (on a single plate).

FIG. 11 is a graph showing the measurement results including spectra of solutions each prepared by adding phosphoric acid to Compound VI (formula [16]).

FIG. 12 is a graph showing the measurement results including spectra of thin films each prepared by applying a solution containing Compound VI (formula [16]) and phosphoric acid (on a single plate).

FIG. 13 is a graph showing the measurement results including a spectrum of a thin film prepared by applying a solution containing Compound I (formula [9]) and hydroquinone (formula [17]) (on a single plate).

FIG. 14 is a graph showing the measurement results including a spectrum of a thin film prepared by applying a solution containing Compound I (formula [9]) and catechol (formula [18]) (on a single plate).

FIG. 15 is a graph showing the measurement results including a spectrum of a thin film prepared by applying a solution containing Compound I (formula [9]) and 2-naphthol (formula [19]) (on a single plate).

FIG. 16 is a graph showing the measurement results including spectra of thin films each prepared by applying a solution containing Compound I (formula [9]) and dimethyl malonate (on a single plate).

FIG. 17 is a graph showing the measurement results including spectra of thin films each prepared by applying a solution containing Compound I (formula [9]) and sodium acetate (on a single plate).

### DESCRIPTION OF THE PREFERRED EMBODIMENTS

In at least one embodiment of the present invention, a thin film containing a J-aggregate is formed using a mono(aza)methine dye composition prepared by adding an acid to a mono(aza)methine compound represented by general formula [1] or [2]. Accordingly, optical information recording media (an HD DVD-R disc 1 and a Blu-ray Disc-R disc 20) each having a uniform optical recording layer with a high refractive index can be realized using a solution or a dispersion liquid containing the dye composition by a simple spin-coating method.

In the mono(aza)methine compound (mono(aza)methine cyanine dye) represented by general formula [1] or [2], when A in the molecular (dye) skeleton is CH, the compound is a monomethine cyanine dye, and when A in the molecular (dye) skeleton is N, the compound is a monoazamethine cyanine dye. When at least one of Y₁ and Y₂ is 0, the compound includes an oxazole nucleus. When at least one of Y₁ and Y₂ is S, the compound includes a thiazole nucleus. When at least one of Y₁ and Y₂ is N, the compound includes an imidazole nucleus. When at least one of Y₁ and Y₂ is CH═CH, the compound includes a pyridine nucleus. Y₁ and Y₂ may be the same or different. Accordingly, the compound has a structure in which these nuclei are bonded by a monomethine chain or a monoazomethine chain (—N═) and is referred to as a mono(aza)methine cyanine compound (mono(aza)methine cyanine dye).

In general formulae [1] and [2], 1/m X^{m-} represents at least one anion selected from the group consisting of an organic anion, an inorganic anion, and an organometallic anion wherein m represents an integer of 1 to 4. When m is 1, the anion has a single negative charge. When m is 2, 3, or 4, the anion has m negative charges. In such a case, the number of charges of the anion is multiplied by 1/m so as to correspond to a single negative charge. Specific examples of the organic anion include anions (negative ions) of alkyl carboxylic acids such as CH₃COO⁻, trifluoromethyl carboxylic acid (CF₃COO⁻), alkylsulfonic acid such as CH₃SO₃—, benzenesulfonic acid (φ-SO₃⁻, wherein φ represents a benzene ring, hereinafter the same), toluenesulfonic acid (H₃C-φ-SO₃⁻ ), and benzenecarboxylic acid (φ-COO⁻). Specific examples of the inorganic anion include halogen atom ions (such as Cl⁻, Br⁻, and I⁻); PF₆⁻; SbF₆⁻; anions (negative ions) of phosphoric acid, perchloric acid (ClO₄⁻), periodic acid, and fluoroboric acid (BF₄⁻); NO₃⁻; OH⁻; SCN⁻; and anions of tetraphenylborate and tungstic acid.

In general formula [1], Z₁ and Z₂ each represent an atomic group required for forming a five- or six-membered aromatic ring or a five- or six-membered nitrogen-containing heterocyclic ring (i.e., forming any one of cyclic groups selected from a five-membered aromatic ring, a six-membered aromatic ring, a five-membered nitrogen-containing heterocyclic ring, and a six-membered nitrogen-containing heterocyclic ring), Z₁ and Z₂ may be the same or different, and each of Z₁ and Z₂ may have a substituent.

Examples of the aromatic ring include a substituted or unsubstituted benzene ring or a substituted or unsubstituted naphthalene ring. In general formula [1], Z¹ represents any one of four atomic groups represented by general formula [3], Z₂ represents any one of four atomic groups represented by general formula [4], and Z₁ and Z₂ may be the same or different (wherein D₁ and D₂ each represent a substituent selected from a hydrogen atom, an alkyl group, an alkoxyl group, a hydroxyl group, a halogen atom, a carboxyl group, an alkoxycarbonyl group, an alkylcarboxyl group, an alkylhydroxyl group, an aralkyl group, an alkenyl group, an alkylamido group, an alkylamino group, an alkylsulfonamido group, an alkylcarbamoyl group, an alkylsulfamoyl group, an alkylsulfonyl group, a phenyl group, a cyano group, an ester group, a nitro group, an acyl group, an allyl group, an aryl group, an aryloxy group, an alkylthio group, an arylthio group, a phenylazo group, a pyridinoazo group, an alkylcarbonylamino group, a sulfonamido group, an amino group, an alkylsulfone group, a thiocyano group, a mercapto group, a chlorosulfone group, an alkylazomethine group, an alkylaminosulfone group, a vinyl group, and a sulfone group, D₁ and D₂ may be the same or different, p and q each represent the number of substituents and represent 1 or an integer of a plural number).

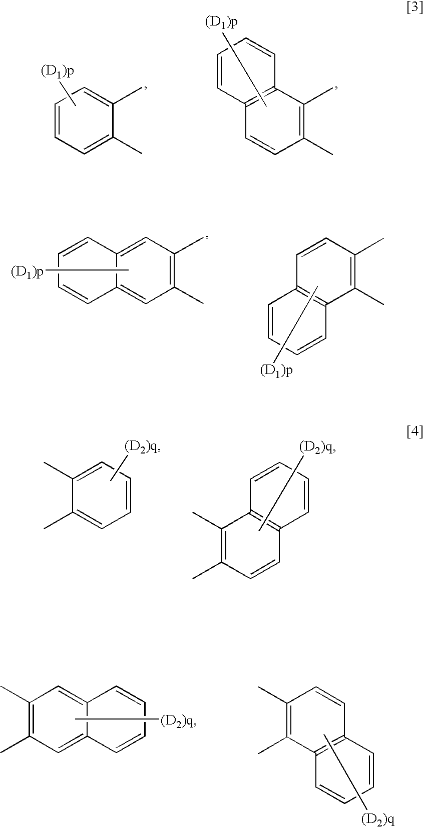

In general formula [2], each of R₃, R₄, R₅, and R₆ may be selected from the group consisting of a hydrogen atom, a halogen atom, an alkoxy group, a cyano group, a halogenated alkyl group, a phenyl group which may have a substituent, and an alkyl group of (CH)ₙCH₃ (wherein n represents an integer selected from 0 to 5). Furthermore, each of R₃, R₄, R₅, and R₆ may be selected from the group consisting of other aromatic rings and heterocyclic rings. The selected one may have a substituent, and R₃, R₄, R₅, and R₆ may be the same or different. However, at least one of R₃ to R₆ is preferably a C1 group. Also, the benzene rings disposed at both sides of the mono(aza)methine chain preferably have C1 groups symmetrically.

More specifically, in general formula [2], at least one of R₃ to R₆ may be substituted with a substituent. Examples of the substituent include aliphatic hydrocarbon groups such as a methyl group, an ethyl group, a propyl group, an isopropyl group, a butyl group, an isobutyl group, a sec-butyl group, a tert-butyl group, a pentyl group, an isopentyl group, a neopentyl group, and a tert-pentyl group; halogenated aliphatic hydrocarbon groups such as halogenated alkyl groups; ether groups such as a methoxy group, a trifluoromethoxy group, an ethoxy group, a propoxy group, an isopropoxy group, a butoxy group, a tert-butoxy group, a pentyloxy group, a phenoxy group, and a benzyloxy group; ester groups such as a methoxycarbonyl group, a trifluoromethoxycarbonyl group, an ethoxycarbonyl group, a propoxycarbonyl group, an acetoxy group, a trifluoroacetoxy group, and a benzoyloxy group; alkylsulfonyl groups such as a methylsulfonyl group, an ethylsulfonyl group, a propylsulfonyl group, an isopropylsulfonyl group, a butylsulfonyl group, a tert-butylsulfonyl group, and a pentylsulfonyl group; alkylsulfamoyl groups such as a methylsulfamoyl group, a dimethylsulfamoyl group, an ethylsulfamoyl group, a diethylsulfamoyl group, a propylsulfamoyl group, a dipropylsulfamoyl group, a butylsulfamoyl group, a dibutylsulfamoyl group, a pentylsulfamoyl group, and a dipentylsulfamoyl group; halogen groups such as a fluoro group, a chloro group, a bromo group, and an iodo group; and a nitro group; and a cyano group. Each of R₃ to R₆ may have at least one substituent. All of or some of R₃ to R₆ may be the same or different. Each of the aromatic rings is a monocyclic benzene ring (may also be a phenyl group which may have a substituent), and each of the heterocyclic rings preferably has at least one heteroatom selected from a nitrogen atom, an oxygen atom, a sulfur atom, a selenium atom, and a tellurium atom. The aromatic rings and the heterocyclic rings may be the same or different between (R₃, R₄) and (R₅, R₆), and each of the rings may have at least one substituent.

These aromatic rings and the heterocyclic rings may have at least one of the following substituents. Examples thereof include aliphatic hydrocarbon groups such as a methyl group, an ethyl group, a propyl group, an isopropyl group, a butyl group, an isobutyl group, a sec-butyl group, a tert-butyl group, a pentyl group, an isopentyl group, a neopentyl group, a tert-pentyl group, a 1-methylpentyl group, a 2-methylpentyl group, a hexyl group, an isohexyl group, and a 5-methylhexyl group; alicyclic hydrocarbon groups such as a cyclopropyl group, a cyclobutyl group, a cyclopentyl group, a cyclohexyl group, and a cyclohexenyl group; aromatic hydrocarbon groups such as a phenyl group, a biphenylyl group, an o-tolyl group, a m-tolyl group, a p-tolyl group, an o-cumenyl group, a m-cumenyl group, a p-cumenyl group, a xylyl group, a mesityl group, a styryl group, a cinnamoyl group, and a naphthyl group; ester groups such as a methoxycarbonyl group, an ethoxycarbonyl group, a propoxycarbonyl group, an acetoxy group, and a benzoyloxy group; substituted or unsubstituted aliphatic, alicyclic, or aromatic amino groups such as a primary amino group, a methylamino group, a dimethylamino group, an ethylamino group, a diethylamino group, a propylamino group, a dipropylamino group, an isopropylamino group, a diisopropylamino group, a butylamino group, and a dibutylamino group; alkylsulfamoyl groups such as a methylsulfamoyl group, a dimethylsulfamoyl group, an ethylsulfamoyl group, a diethylsulfamoyl group, a propylsulfamoyl group, a dipropylsulfamoyl group, an isopropylsulfamoyl group, a diisopropylsulfamoyl group, a butylsulfamoyl group, and a dibutylsulfamoyl group; a carbamoyl group; a carboxyl group; a cyano group; a nitro group; a hydroxy group; a sulfo group; a sulfoamino group; and a sulfonamido group.

In the mono(aza)methine compounds (mono(aza)methine cyanine dyes) represented by general formula [1] or [2], when cis/trans structural isomers are present, both isomers are included in at least one embodiment of the present invention.

More specifically, in addition to compounds described in examples described below, monomethine cyanine compounds represented by formulae [5] to [8] are also included in at least one embodiment of the present invention.

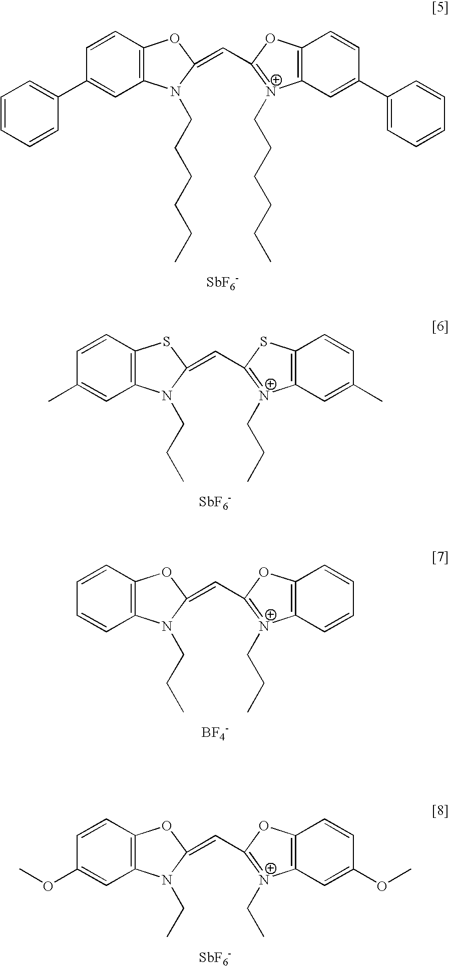

A mono(aza)methine compound represented by general formula [1] or [2], or any of the specific compounds that are described above or below and that belong to general formula [1] or [2], an acid, and a solvent are selected. A dye composition containing the former two components or a dye composition containing these three components is prepared in the form of a solution or a dispersion liquid. A thin film containing a J-aggregate of the mono(aza)methine compound can be easily formed by a spin-coating method using the solution or the dispersion liquid.

Examples of the acid added include, but are not limited to, inorganic acids such as phosphoric acid, hydrochloric acid, nitric acid, sulfuric acid, and hydrofluoric acid; organic acids such as acetylsalicylic acid, (HOOC-φ-OCOCH₃ (ortho isomer) (formula [20] shown below)), hydroquinone (HO-φ-OH (para isomer) (formula [17] shown below)), catechol (HO-φ-OH (ortho isomer) (formula [18] shown below)), and 2-naphthol (φφ-OH (wherein φφ represents a naphthalene ring) (formula [19] shown below)); and derivatives thereof.

The molar ratio of H+(one hydrogen ion) in the acid to one molecule of the mono(aza)methine compound represented by general formula [1] or [2], or any of the specific compounds that are described above or below and that belong to general formula [1] or [2] is preferably in the range of 0.8 to 3, and more preferably, in the range of 1 to 3.

A fluorinated alcohol such as 2,2,3,3-tetrafluoro-1-propanol is preferably used as the solvent. Other solvents such as chloroform, dichloroethane, methyl ethyl ketone, dimethylformamide, methanol, toluene, cyclohexanone, acetylacetone, diacetone alcohol, cellosolves such as methyl cellosolve, and dioxane may be used alone or in combinations to the extent that a substrate is not corroded. At least one of these solvents may be used in combination with a fluorinated alcohol.

By using such a dye material that forms a J-aggregate, the refractive index of the optical recording layer 3 can be increased, the thickness of the optical recording layer 3 can be easily decreased, a high degree of modulation can be ensured, and optical information recording media 1 and 20 having excellent recording properties over a wavelength range of about 350 to 500 nm can be produced. More specifically, by breaking the J-aggregation during recording, the difference in the refractive index before and after recording is ensured, and the recording sensitivity can be improved.

Thermal decomposition of general dyes is conducted by an exothermic reaction, whereas thermal decomposition in the J-aggregate state of the mono(aza)methine compound used in at least one embodiment of the present invention is conducted by an endothermic reaction. Therefore, heat dissipation during decomposition can be suppressed.

In the present disclosure where conditions and/or structures are not specified, the skilled artisan in the art can readily provide such conditions and/or structures, in view of the present disclosure, as a matter of routine experimentation.

Also, in the present disclosure, the numerical numbers applied in embodiments can be modified by ±50% in other embodiments, and the ranges applied in embodiments may include or exclude the endpoints.

### EXAMPLES

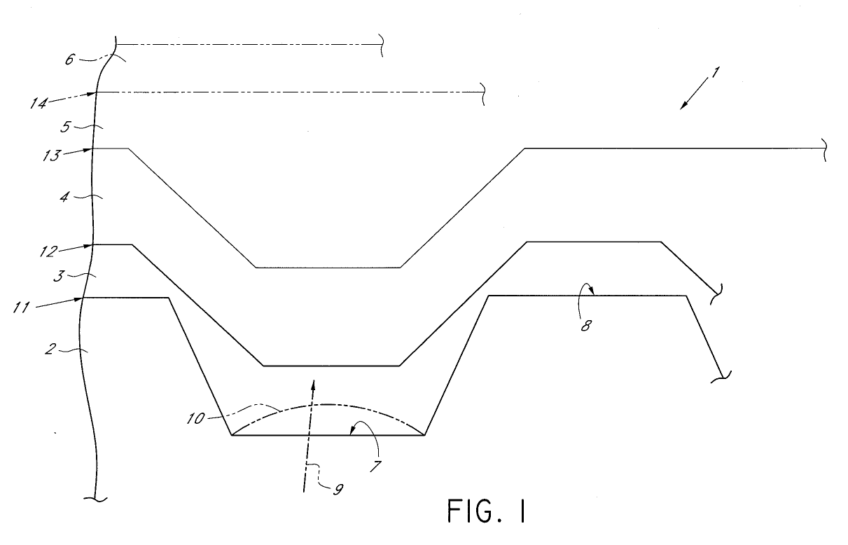

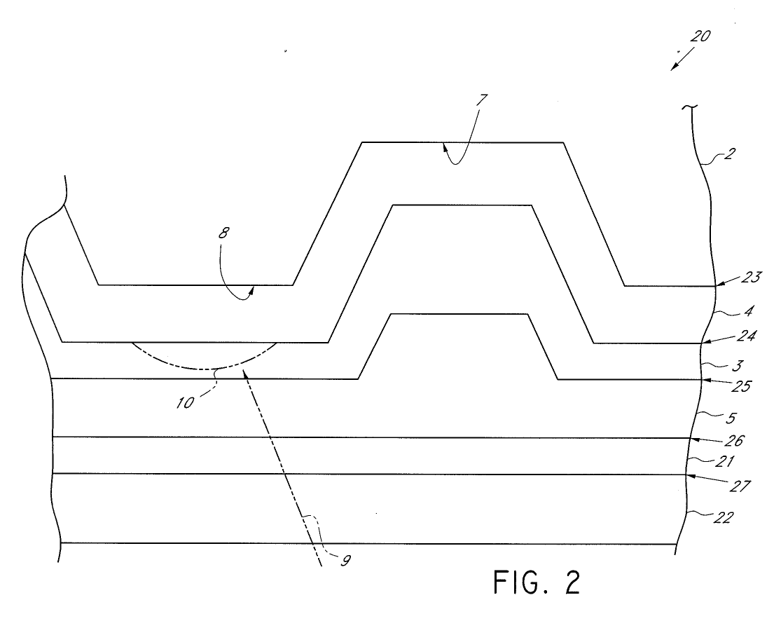

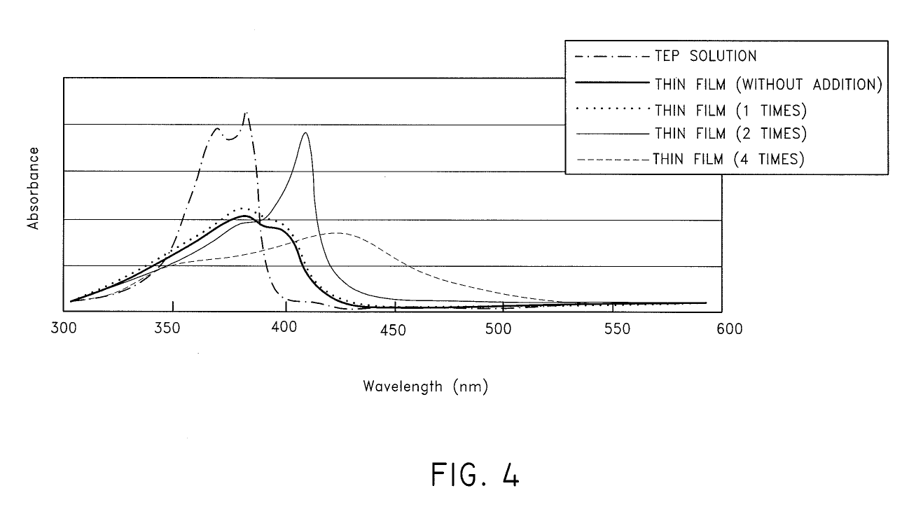

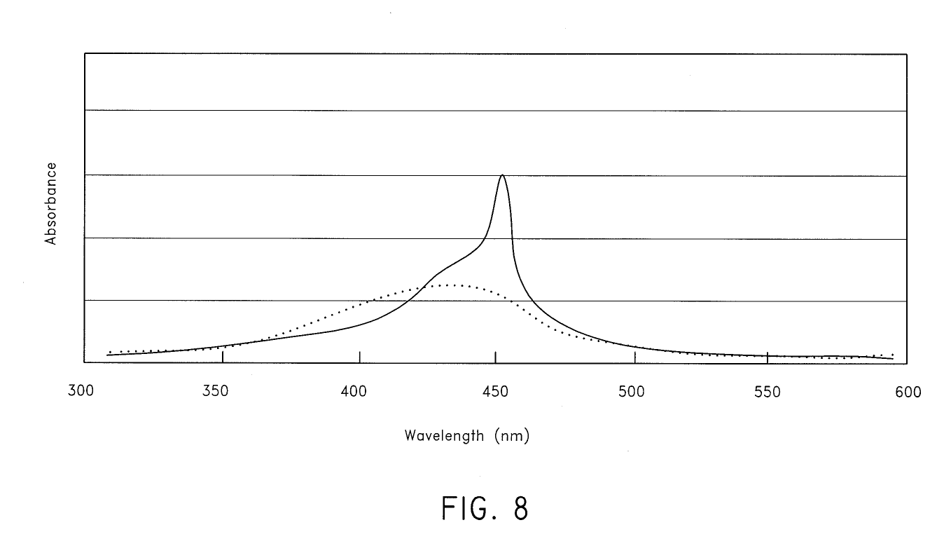

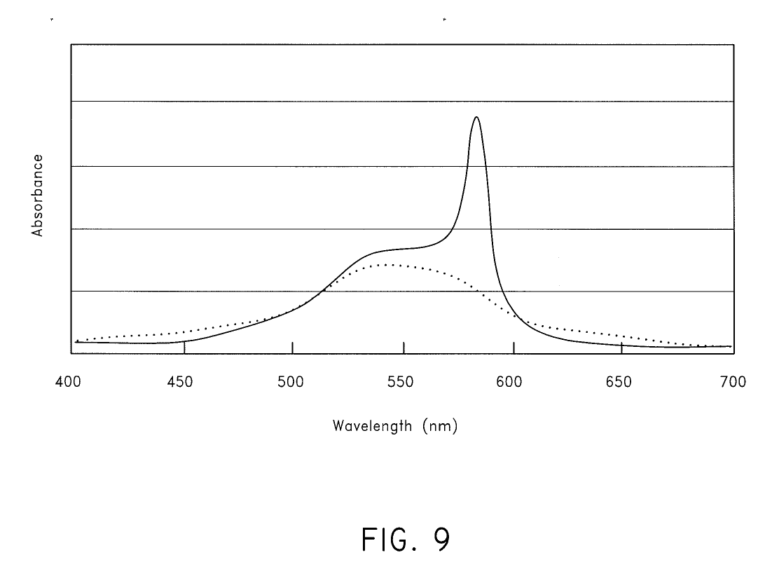

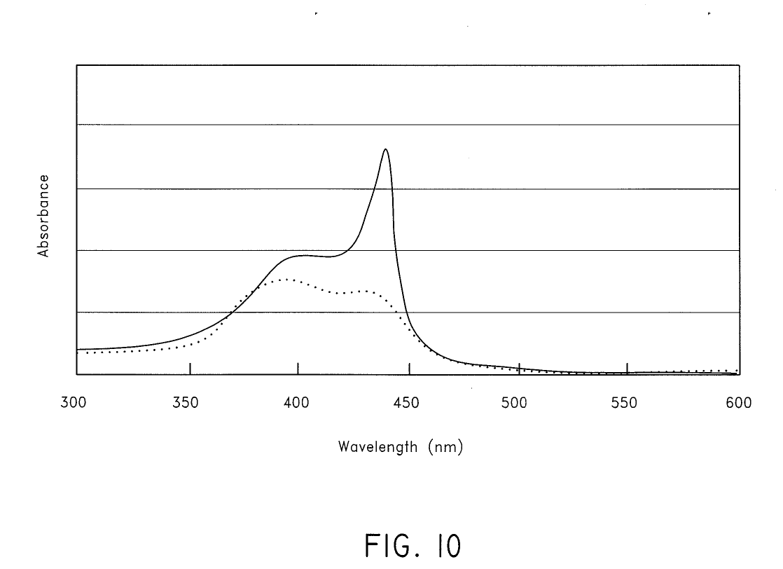

Dye materials for an optical information recording medium, optical information recording media including the dye materials, and methods of producing the optical information recording medium according to examples of the present invention will now be described with reference to FIGS. 4 to 17. However, these examples are not intended to limit the present invention. In EXAMPLES 10 and 11, the same parts as those in FIGS. 1 and 2 are assigned the same reference numerals, and a detailed description of those parts is omitted.

### Example 1

First, 2.0 g of a monomethine cyanine compound (Compound I) represented by formula [9] below was fed in a 100-mL flask. Phosphoric acid was then added in an amount of 0 times (without addition), 0.5 times (178 mg) (more specifically, the molar ratio of H⁺ to Compound I was 0.5 (1 molecule of Compound I : 0.5 hydrogen ion H⁺), and this also applies to the following cases), 1 times (357 mg), 2 times (714 mg), or 4 times (1,428 mg) the amount of Compound I. Furthermore, 2,2,3,3-tetrafluoro-1-propanol (TFP) was added to each flask so that the total volume reached 100 mL, and the mixture was sufficiently stirred to dissolve the compound. Thus, monomethine dye compositions each containing Compound I in a concentration of 20 g/L were prepared.

Subsequently, 5 mL of each solution of the above monomethine dye composition was dripped to a 1,000-mL volumetric flask, and 2,2,3,3-tetrafluoro-1-propanol was then added to the flask so that the total volume reached 1,000 mL. The mixture was sufficiently stirred, and the spectrum of the resulting solutions was then measured.

Subsequently, 1 mL of each solution of the above monomethine dye composition was dripped to a single plate made of glass with a thickness of 0.6 mm and an area of 4 square centimeters. The glass plate was then rotated at a rotational speed of 300 rpm for 30 seconds, thereby preparing a uniform J-aggregate thin film by spin coating. The spectrum of the thin film of each monomethine dye composition was measured.

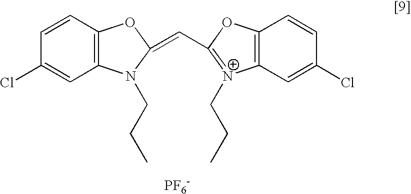

### Comparative Example 1

For comparison, a monomethine cyanine dye (Compound X) represented by formula [10] below was used as a cyanine dye compound. As in the above-described case of Compound I, phosphoric acid was added in an amount of 0 times (without addition), 0.5 times (178 mg), 1 times (357 mg), 2 times (714 mg), or 4 times (1,428 mg) the amount of Compound X. Solutions of the monomethine dye composition each containing Compound X in a concentration of 20 g/L were prepared. Each of these solutions was applied on a single plate by spin coating as in Example 1. The spectrum of each thin film prepared by the coating was measured.

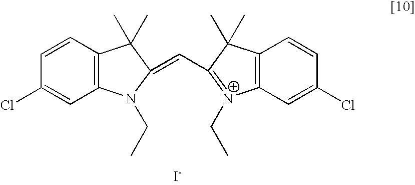

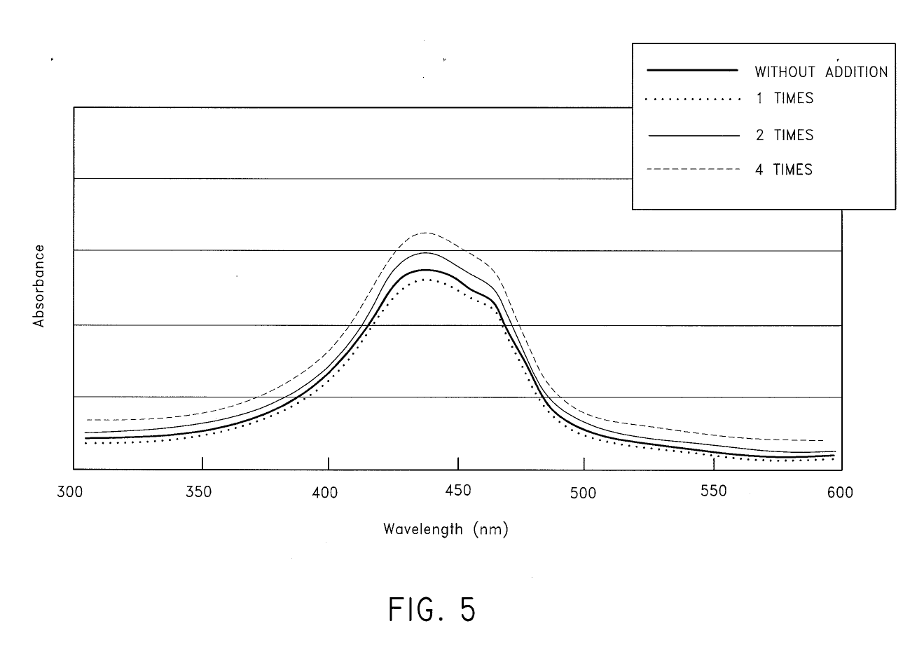

FIG. 4 shows the measurement results of the spectrum of Compound I, and FIG. 5 shows the measurement results of the spectrum of Compound X. In FIG. 4, a peak of the absorption spectrum of the thin films each formed on the single plate was shifted to the long-wavelength side compared with a peak of the absorption spectrum (shown by the chain line, a TFP solution) of a solution of Compound I. The absorption shown by the dotted line (thin film (with addition of phosphoric acid in an amount of 1 times the amount of Compound I)) tended to be increased compared with that shown by the thick solid line (thin film (without addition of phosphoric acid)). Regarding the result shown by the thin solid line (thin film (with addition of phosphoric acid in an amount of 2 times the amount of Compound I)), with the further addition of phosphoric acid, the peak was further shifted to the long-wavelength side, the peak had a larger height and became sharper, and the full width at half maximum of the peak was decreased. According to these results, when the shape of the spectrum of the thin film on the single plate was compared with that of the solution, the peak was shifted to the long-wavelength side and became sharper (i.e., the full width at half maximum of the peak was decreased), which are features of the J-aggregation. The result shown by the long-dot line (thin film (with addition of phosphoric acid in an amount of 4 times the amount of Compound I)) showed that, even in the case of a thin film, when phosphoric acid was added in an excessive amount, the J-aggregate was broken.

In contrast, referring to the absorption spectra of Compound X on the single plate in FIG. 5, the position of the peak of each spectrum was not changed. The absorption shown by the dotted line (thin film (with addition of phosphoric acid in an amount of 1 times the amount of Compound X)) and the absorption shown by the thin solid line (thin film (with addition of phosphoric acid in an amount of 2 times the amount of Compound X)) were somewhat smaller than that shown by the thick solid line (thin film (without addition of phosphoric acid)). The absorption shown by the long-dot line (thin film (with addition of phosphoric acid in an amount of 4 times the amount of Compound X)) was somewhat larger than that shown by the thick solid line (thin film (without addition of phosphoric acid)). However, a significant difference was not observed in these thin films. A shift in the position of the peak to the long-wavelength side, sharpening of the peak, or a decrease in the full width at half maximum of the peak due to the addition of phosphoric acid was not observed. Accordingly, these results showed that a shift in the position of the peak to the long-wavelength side or sharpening of the peak (a decrease in the full width at half maximum of the peak), which is a feature of the J-aggregation, was not observed.

As described above, the formation of a J-aggregate of a dye film can be confirmed by observing a change in the absorption spectra of a solution of a compound and a thin film thereof.

For example, when the absorption peak of the thin film is shifted to the long-wavelength side compared with the absorption peak of the solution, and when the full width at half maximum of the absorption spectrum of the thin film is smaller than that of the absorption spectrum of the solution, the formation of the J-aggregate can be confirmed.

However, the method is not limited thereto and various methods can be employed. For example, the formation of the J-aggregate can also be confirmed by comparing an absorption spectrum of a monomer in a solution with an absorption spectrum of a thin film by the method described above.

Table 1 (see Example 10 described later) shows optical properties of thin films (each formed on a single plate) of Compound I (with addition of phosphoric acid in an amount of 2 times the amount of Compound I) and Compound X at a wavelength of 405 nm. The refractive index n of Compound I (with addition of phosphoric acid in an amount of 2 times the amount of Compound I) was improved by forming a J-aggregate, and thus, satisfactory optical properties were obtained.

TABLE 1

| | | Recording | | |
|---|---|---|---|---|
| | n/k | sensitivity | | |
| | (405 nm) | (1×)/mW | 8T C/N dB | 2T C/N dB |
| Compound I | 2.1/0.15 | 9.2 | 53.1 | 38.6 |
| Compound X | 1.8/0.12 | 12.8 | 52 | 27.8 |

As described above, in the cyanine dye thin films of Compound I (without addition of phosphoric acid) and Compound X, no J-aggregates were formed. In the monomethine compound of Compound I, in particular, when phosphoric acid was added in an amount of two times the amount of the compound, a J-aggregate was formed. By applying this composition by spin coating, a uniform J-aggregate thin film could be formed more easily.

### Comparative Example 2

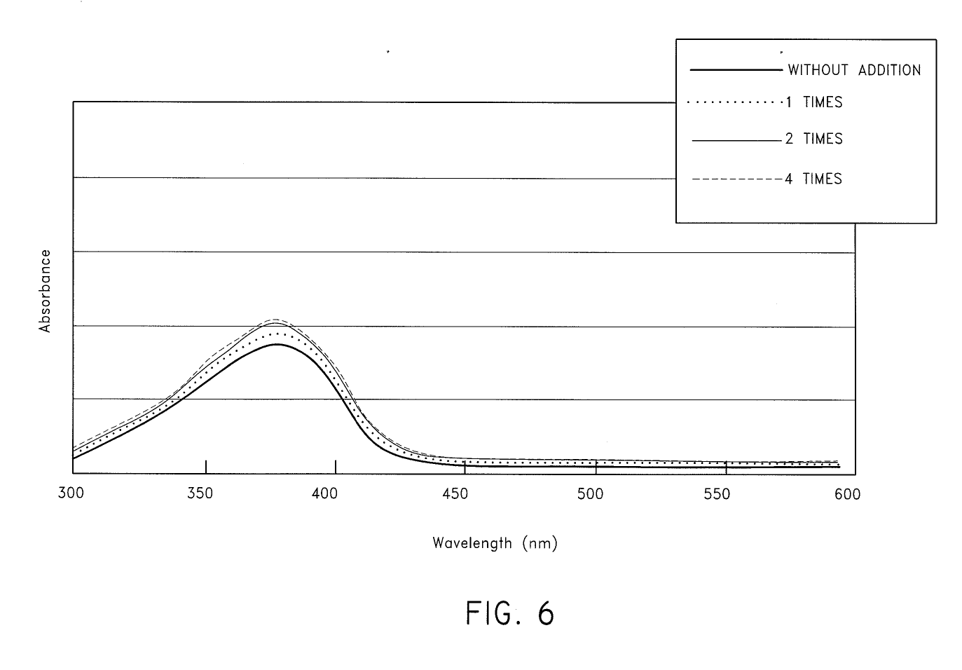

A monomethine cyanine dye (Compound XI) represented by formula [11] below was used instead of Compound X. As in the above-described case of Compound X, phosphoric acid was added in an amount of 0 times (without addition), 1 times, 2 times, or 4 times the amount of Compound XI to prepare solutions. Each of these solutions was applied on a single plate by spin coating as in Comparative Example 1. The spectrum of each thin film of Compound XI formed on the single plate was measured. FIG. 6 shows the results.

Referring to the absorption spectra of Compound XI on the single plate in FIG. 6, the position of the peak of each spectrum was not changed. The absorption shown by the dotted line (thin film (with addition of phosphoric acid in an amount of 1 times the amount of Compound XI)), the absorption shown by the thin solid line (thin film (with addition of phosphoric acid in an amount of 2 times the amount of Compound XI)), and the absorption shown by the long-dot line (thin film (with addition of phosphoric acid in an amount of 4 times the amount of Compound XI)) were somewhat larger than that shown by the thick solid line (thin film (without addition of phosphoric acid)). However, a significant difference was not observed in these thin films. A shift in the position of the peak to the long-wavelength side, sharpening of the peak, or a decrease in the full width at half maximum of the peak due to the addition of phosphoric acid was not observed. Accordingly, these results showed that a shift in the position of the peak to the long-wavelength side or sharpening of the peak (a decrease in the full width at half maximum of the peak), which is a feature of the J-aggregation, was not observed.

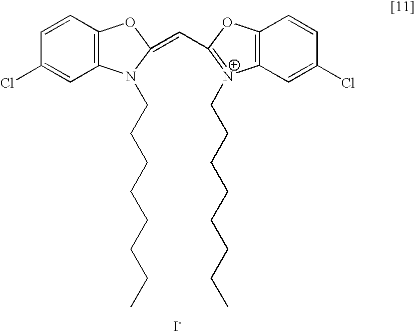

### Examples 2 to 5

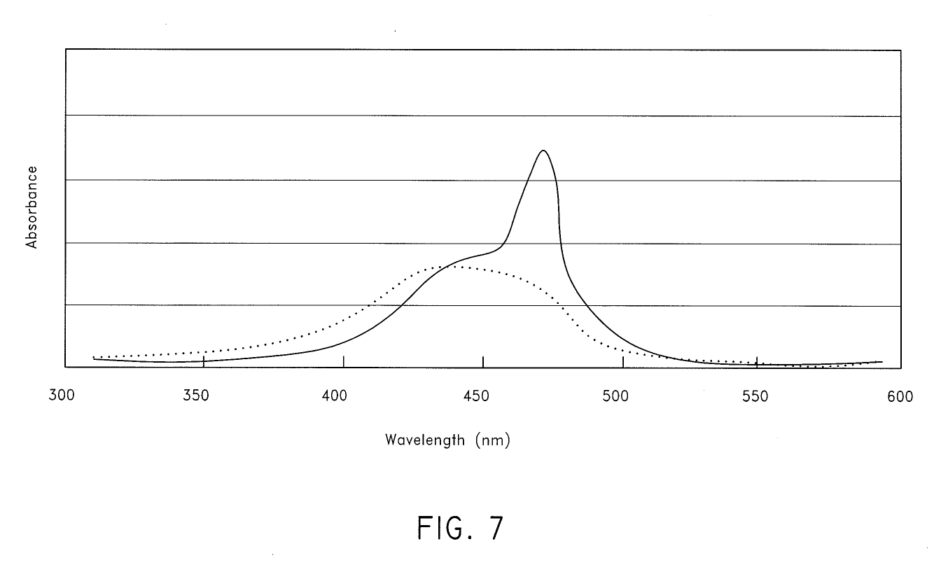

Monomethine cyanine dyes (Compounds II, III, IV, and V) represented by formulae [12], [13], [14], and [15], respectively, were used instead of Compound I in Example 1. As in the above-described case of Compound I, phosphoric acid was added in an amount of 1 times or 2 times the amount of each compound to prepare solutions. Each of these solutions was applied on a single plate by spin coating as in Example 1. The spectrum of each thin film of Compound II, III, IV, or V formed on the single plate was measured. FIGS. 7, 8, 9, and 10 show the results of Compounds II, III, IV, and V, respectively.

Referring to the absorption spectra of thin films on the single plates in FIGS. 7 to 10, when the absorption spectrum shown by the thin solid line (thin film (with addition of phosphoric acid in an amount of 2 times the amount of compound)) was compared with that shown by the dotted line (thin film (with addition of phosphoric acid in an amount of 1 times the amount of compound)), with the further addition of phosphoric acid, the peak was shifted to the long-wavelength side, the peak became sharper, and the full width at half maximum of the peak was decreased. Accordingly, these results showed that a shift in the position of the peak to the long-wavelength side and sharpening of the peak (a decrease in the full width at half maximum of the peak), which are features of the J-aggregation, were observed in the spectra of the thin films formed on the single plates.

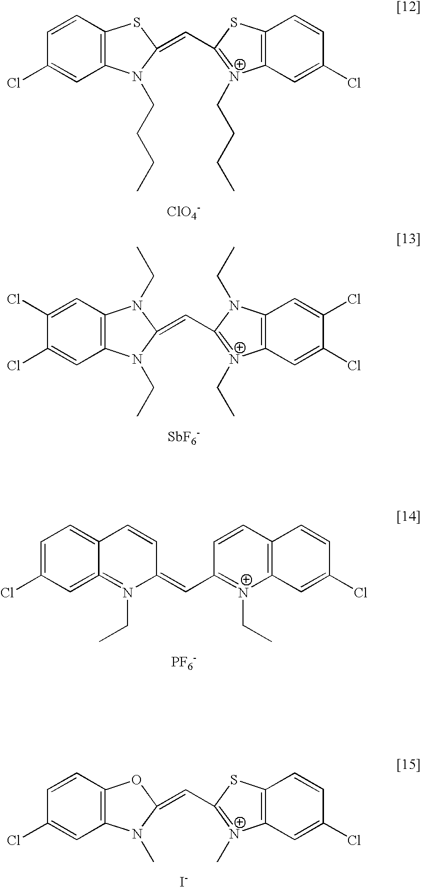

### Example 6

First, 2.0 g of a monoazamethine cyanine compound (Compound VI) represented by formula [16] below was fed in a 100-mL flask. Phosphoric acid was then added in an amount of 0 times (without addition), 0.5 times (160 mg) (more specifically, the molar ratio of H⁺ to Compound VI was 0.5 (1 molecule of Compound VI 0.5 hydrogen ion H⁺), and this also applies to the following cases), 1 times (320 mg), 2 times (640 mg), or 4 times (1,280 mg) the amount of Compound VI. Furthermore, 2,2,3,3-tetrafluoro-1-propanol (TFP) was added to each flask so that the total volume reached 100 mL, and the mixture was sufficiently stirred to dissolve the compound. Thus, monoazamethine dye compositions each containing Compound VI in a concentration of 20 g/L were prepared.

Subsequently, 5 mL of each solution of the above monoazamethine dye composition was dripped to a 1,000-mL volumetric flask, and 2,2,3,3-tetrafluoro-1-propanol was then added to the flask so that the total volume reached 1,000 mL. The mixture was sufficiently stirred, and the spectrum of the resulting solution was then measured.

Subsequently, 1 mL of each solution of the above monoazamethine dye composition containing Compound VI in a concentration of 20 g/L was dripped to a single plate made of glass with a thickness of 0.6 mm and an area of 4 square centimeters. The glass plate was then rotated at a rotational speed of 300 rpm for 30 seconds, thereby preparing a uniform J-aggregate thin film by spin coating.

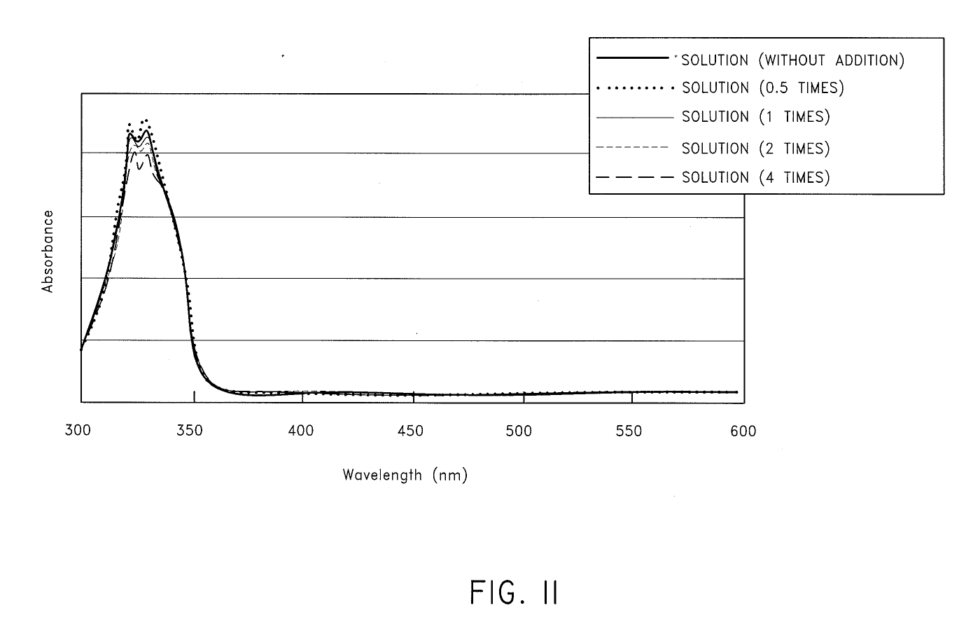

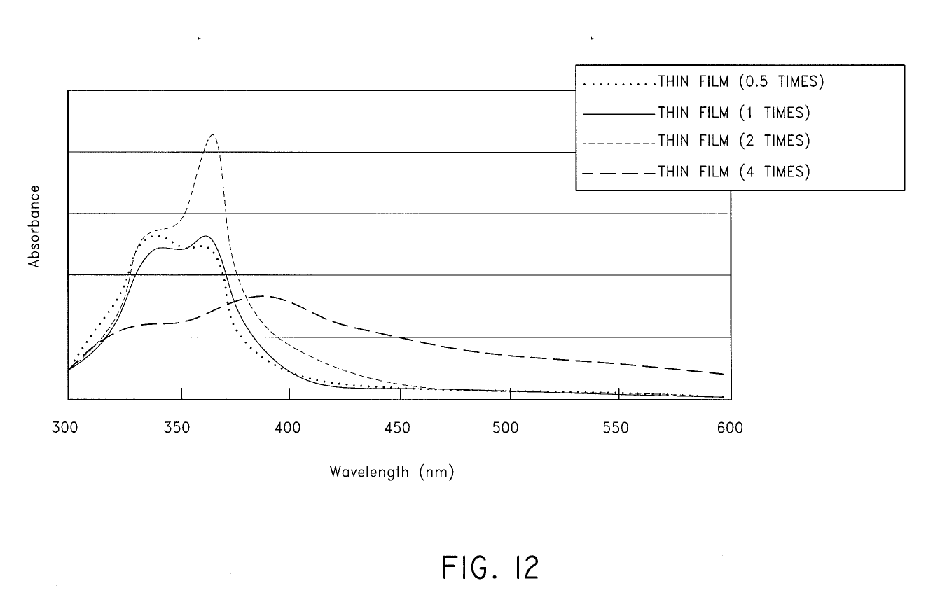

FIG. 11 show the measurement results of spectra of the solutions, and FIG. 12 shows the measurement results of spectra of the thin films. Referring to the absorption spectra of the solutions of Compound VI shown in FIG. 11, regardless of the amount of phosphoric acid added, the wavelength position of the peak of each spectrum was not changed. In contrast, referring to the absorption spectra of the thin films on the single plates shown in FIG. 12, when phosphoric acid was added, the peak was shifted to the long-wavelength side compared with the reference sample (without addition of phosphoric acid). When phosphoric acid was added in an amount of two times the amount of Compound VI, the peak had a larger height and became sharper, and the full width at half maximum of the peak was decreased. According to these results, when the shape of the spectrum of the thin film on the single plate was compared with that of the solution, the peak was shifted to the long-wavelength side and became sharper (i.e., the full width at half maximum of the peak was decreased), which are features of the J-aggregation. Referring to FIG. 12, when phosphoric acid was excessively added (in an amount of 4 times the amount of Compound VI), the J-aggregate was broken.

The results also showed that the absorption spectrum of a thin film of Compound VI (particularly in the case where phosphoric acid was added in an amount of two times the amount of Compound VI) was sharp, compared with the absorption spectrum of a thin film of Compound X (FIG. 5), which did not form a J-aggregate and in which the dye molecules were present in a relatively dispersed state.

Table 1 above shows optical properties of thin films (each formed on a single plate) of Compound I and Compound X at a wavelength of 405 nm. As in the case of Compound I, the refractive index n of Compound VI (with addition of phosphoric acid in an amount of two times the amount of Compound VI) was also improved by forming a J-aggregate, and thus, satisfactory optical properties were obtained.

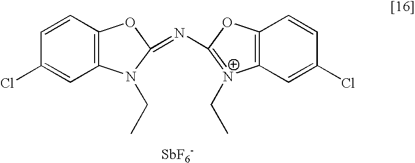

### Example 7

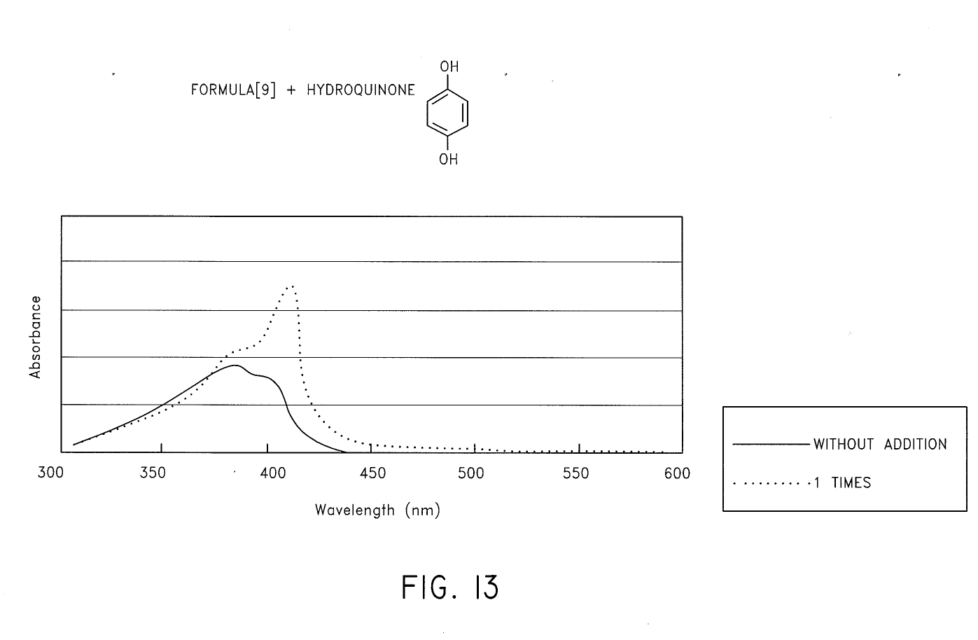

Thin films of monomethine dye compositions were formed (on single plates) as in Example 1 except that hydroquinone (formula [17] shown below) was added in an amount of zero (without addition) or 1 times the amount of Compound I instead of phosphoric acid. The spectrum of each thin film was measured. FIG. 13 shows the results.

Referring to FIG. 13, in the absorption shown by the dotted line (with addition of hydroquinone in an amount of 1 times the amount of Compound I), the absorption was large, the peak was shifted to the long-wavelength side, the peak was sharp, and the full width at half maximum of the peak was decreased, as compared with the absorption shown by the solid line (without addition of hydroquinone). These results showed that a shift in the position of the peak to the long-wavelength side and sharpening of the peak (a decrease in the full width at half maximum of the peak), which are features of the J-aggregation, were observed.

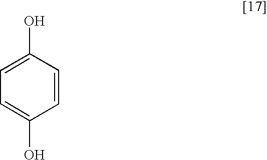

### Example 8

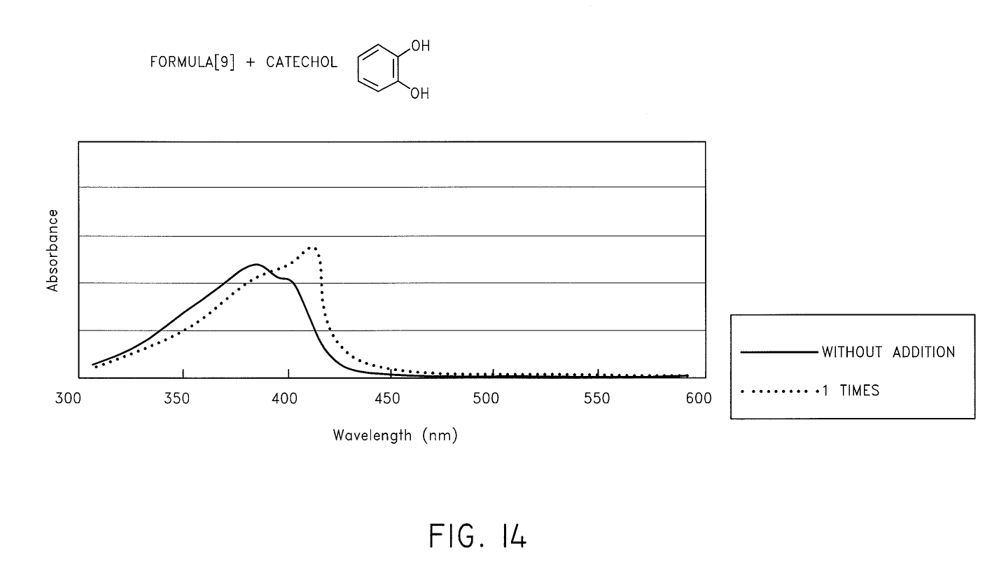

Thin films of monomethine dye compositions were formed (on single plates) as in Example 1 except that catechol (formula [18] shown below) was added in an amount of zero (without addition) or 1 times the amount of Compound I instead of phosphoric acid. The spectrum of each thin film was measured. FIG. 14 shows the results.

Referring to FIG. 14, in the absorption shown by the dotted line (with addition of catechol in an amount of 1 times the amount of Compound I), the absorption was large, the peak was shifted to the long-wavelength side, the peak was sharp, and the full width at half maximum of the peak was decreased, as compared with the absorption shown by the solid line (without addition of catechol). These results showed that a shift in the position of the peak to the long-wavelength side and sharpening of the peak (a decrease in the full width at half maximum of the peak), which are features of the J-aggregation, were observed.

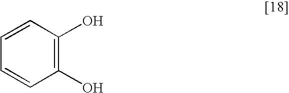

### Example 9

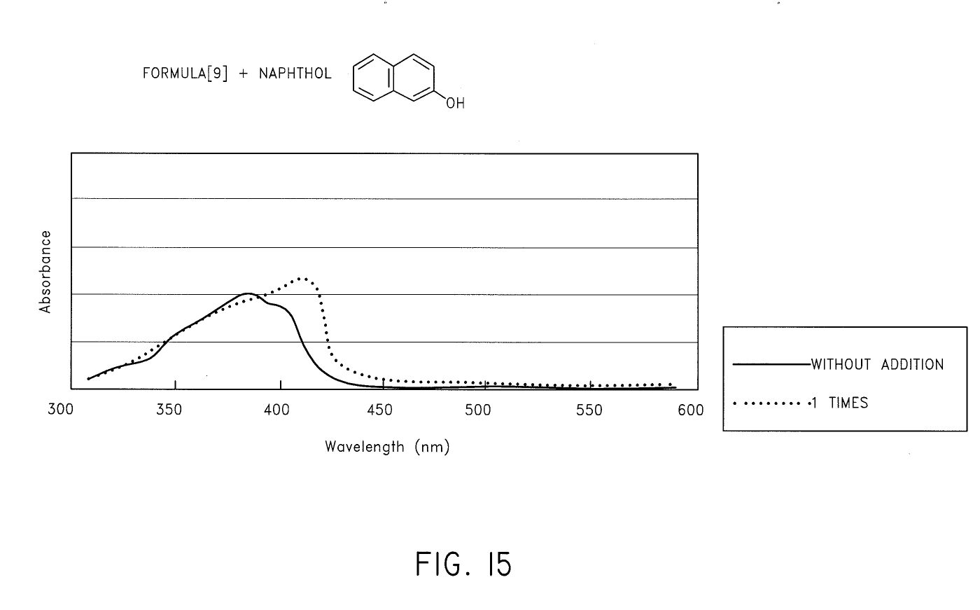

Thin films of monomethine dye compositions were formed (on single plates) as in Example 1 except that 2-naphthol (formula [19] shown below) was added in an amount of zero (without addition) or 1 times the amount of Compound I instead of phosphoric acid. The spectrum of each thin film was measured. FIG. 15 shows the results.

Referring to FIG. 15, in the absorption shown by the dotted line (with addition of naphthol in an amount of 1 times the amount of Compound I), the absorption was large, the peak was shifted to the long-wavelength side, the peak was sharp, and the full width at half maximum of the peak was decreased, as compared with the absorption shown by the solid line (without addition of naphthol). These results showed that a shift in the position of the peak to the long-wavelength side and sharpening of the peak (a decrease in the full width at half maximum of the peak), which are features of the J-aggregation, were observed.

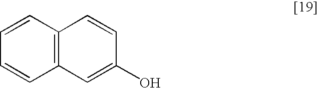

When acetylsalicylic acid (formula [20] shown below) was used as in the above examples instead of the compound represented by formula [17], [18], or [19], the similar results were obtained.

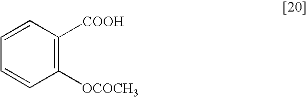

### Comparative Example 3

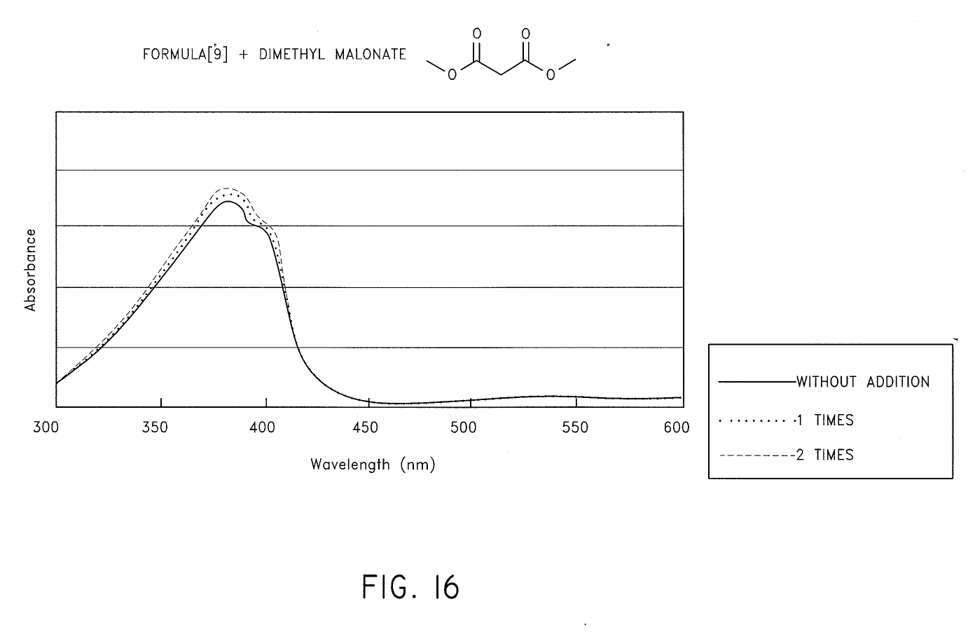

Thin films of monomethine dye compositions were formed (on single plates) as in Example 1 except that dimethyl malonate was added in an amount of zero (without addition), 1 times, or 2 times the amount of Compound I instead of phosphoric acid. The spectrum of each thin film was measured. FIG. 16 shows the results.

Referring to FIG. 16, the position of the peak of each spectrum was not changed. The absorption shown by the dotted line (with addition of dimethyl malonate in an amount of 1 times the amount of Compound I) and the absorption shown by the long-dot line (with addition of dimethyl malonate in an amount of 2 times the amount of Compound I) were somewhat larger than that shown by the solid line (without addition of dimethyl malonate). However, a significant difference was not observed in these thin films. A shift in the position of the peak to the long-wavelength side, sharpening of the peak, or a decrease in the full width at half maximum of the peak was not observed. Accordingly, these results showed that a shift in the position of the peak to the long-wavelength side or sharpening of the peak (a decrease in the full width at half maximum of the peak), which is a feature of the J-aggregation, was not observed.

### Comparative Example 4

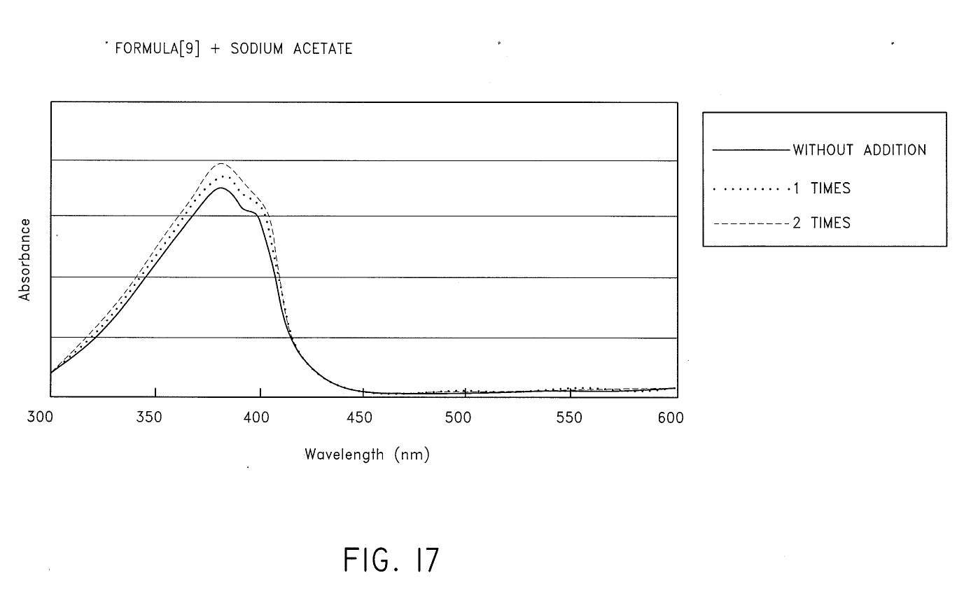

Thin films of monomethine dye compositions were formed (on single plates) as in Example 1 except that sodium acetate was added in an amount of zero (without addition), 1 times, or 2 times the amount of Compound I instead of phosphoric acid. The spectrum of each thin film was measured. FIG. 17 shows the results.

Referring to FIG. 17, the position of the peak of each spectrum was not changed. The absorption shown by the dotted line (with addition of sodium acetate in an amount of 1 times the amount of Compound I) and the absorption shown by the long-dot line (with addition of sodium acetate in an amount of 2 times the amount of Compound I) were somewhat larger than that shown by the solid line (without addition of sodium acetate). However, a significant difference was not observed in these thin films. A shift in the position of the peak to the long-wavelength side, sharpening of the peak, or a decrease in the full width at half maximum of the peak was not observed. Accordingly, these results showed that a shift in the position of the peak to the long-wavelength side or sharpening of the peak (a decrease in the full width at half maximum of the peak), which is a feature of the J-aggregation, was not observed.

### Example 10

A description will be made of an example in which a thin film of the monomethine dye composition (J-aggregate monomethine dye thin film) used in Example 1, which was prepared by adding phosphoric acid and the solvent to Compound I, was used for an optical recording layer 3 of an HD DVD-R disc 1.

First, 2.0 g of a monomethine cyanine compound (Compound I) represented by formula [9] was dissolved in 100 mL of 2,2,3,3-tetrafluoro-1-propanol. Furthermore, 714 mg of phosphoric acid was added to the solution (in an amount of 2 times the amount of Compound I (the molar ratio of H+to Compound I being 2)), thus preparing a solution of Compound I having a concentration of 20 g/L. Compound VII represented by formula [21] serving as a light stabilizer was added to the solution in an amount of 30 weight percent. Other stabilizers such as an aminium compound or a diimonium compound may also be used.

A disc-shaped polycarbonate substrate 2 having a pregroove 7 with a pitch of 0.40 μm was prepared. Subsequently, 1 mL of the resulting solution was applied on the substrate 2 having an outer diameter of 120 mm and a thickness of 0.6 mm by a spin-coating method at a predetermined rotational speed, thereby preparing a uniform J-aggregate thin film.

The transparent substrate 2 having the dye thereon was heat-treated at 80° C. for 30 minutes to volatilize the residual excessive solvent and moisture, thus forming a dye surface (optical recording layer 3).

Furthermore, a light-reflecting layer 4 having a thickness of 100 nm was formed on the optical recording layer 3 by sputtering silver (Ag).

The dye applied on the peripheral edge of the substrate 2 during coating was removed by washing with methanol.

Furthermore, a UV curable resin adhesive SD-318 (manufactured by Dainippon Ink and Chemicals, Incorporated) was applied on the light-reflecting layer 4 by spin coating. The adhesive was then cured by irradiation of ultraviolet rays to form a protective layer 5.

A UV curable resin adhesive was applied on the surface of the protective layer 5, and a dummy substrate 6 whose material and shape (thickness: 0.6 mm, outer diameter: 120 mm) were the same as those of the substrate 2 was bonded to the protective layer 5. The adhesive was then cured by irradiation of ultraviolet rays, thereby bonding the dummy substrate 6. Thus, the HD DVD-R (write-once HD DVD) disc 1 was prepared.

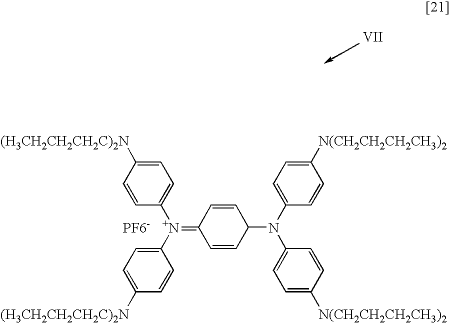

As described above, the HD DVD-R disc 1 having the optical recording layer 3 composed of a uniform thin film containing a J-aggregate of a monomethine cyanine dye compound was obtained using the monomethine dye composition containing Compound I and phosphoric acid.

In addition, an optical recording layer 3 was formed as in the above example to prepare an HD DVD-R disc 1 except that Compound X used in Comparative Example 1 was used instead of Compound I.

Table 1 also shows evaluation results of electrical properties of the HD DVD-R discs 1. The power required for recording onto the HD DVD-R disc 1 having the optical recording layer 3 made of the monomethine dye composition containing Compound I and phosphoric acid was lower than that onto the HD DVD-R disc 1 prepared using Compound X. Therefore, in the HD DVD-R disc 1 in Example 10, the recording sensitivity was more satisfactory, the C/N level in the shortest mark length could be improved, and symmetry during recording of random recording signals could be achieved with a low power.

### Example 11

An HD DVD-R (write-once HD DVD) disc 1 having an optical recording layer 3 composed of a uniform thin film containing a J-aggregate of a monoazamethine cyanine dye compound was prepared as in Example 10 except that, instead of 2.0 g of Compound I, Compound VI used in Example 6 was used so that the number of moles of Compound VI was the same as that of Compound I in Example 10.

According to the evaluation of electrical properties of this HD DVD-R disc 1, results similar to those of the HD DVD-R disc 1 that was prepared using Compound I in Table 1 were obtained. The power required for recording onto the HD DVD-R disc 1 having the optical recording layer 3 made of the monoazamethine dye composition containing Compound VI and phosphoric acid was lower than that onto the HD DVD-R disc 1 prepared using Compound X. Therefore, in the HD DVD-R disc 1 in Example 11, the recording sensitivity was more satisfactory, the C/N level in the shortest mark length could be improved, and symmetry during recording of random recording signals could be achieved with a low power.

Blu-ray Disc-R (write-once Blu-ray) discs 20 were prepared as in Examples 10 and 11 using each of Compounds I and VI and phosphoric acid. Evaluation results similar to those of the HD DVD-R (write-once HD DVD) discs 1 in Examples 10 and 11 were obtained.

The present application claims priority to Japanese Patent Application No. 2006-139888, filed May 19, 2006, the disclosure of which is incorporated herein by reference in its entirety.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. An optical information recording medium comprising:
an optical recording layer onto which information is to be recorded by a laser beam,
wherein the optical recording layer includes a dye film containing a mono(aza)methine compound represented by general formula [1] and an acid: 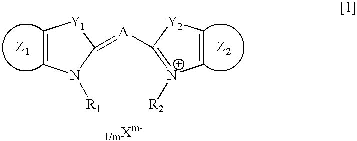
wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may have a substituent; Y₁ and Y₂ each represent one selected from the group consisting of O, S, N—R (wherein R represents an alkyl group of (CH)ₙCH₃, wherein n represents an integer selected from 0 to 5), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; and 1/m X^{m-} (wherein m represents an integer selected from 1 to 4) represents at least one anion selected from the group consisting of an organic anion, an inorganic anion, and an organometallic anion.

2. The optical information recording medium according to claim 1, wherein the mono(aza)methine compound represented by general formula [1] is a mono(aza)methine compound represented by general formula [2]: 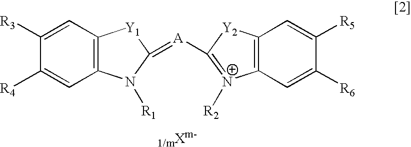
wherein Y₁ and Y₂ each represent one selected from the group consisting of O, S, N—R (wherein R represents an alkyl group of (CH)ₙCH₃, wherein n represents an integer selected from 0 to 5), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; 1/m X^{m-} (wherein m represents an integer selected from 1 to 4) represents at least one anion selected from the group consisting of an organic anion, an inorganic anion, and an organometallic anion; and R₃ to R₆ each represent one selected from the group consisting of a hydrogen atom, a linear or branched aliphatic hydrocarbon group, a halogenated aliphatic hydrocarbon group, a halogen atom, an ether group, an ester group, an alkylsulfamoyl group, a nitro group, a cyano group, an aromatic ring, and a heterocyclic ring, each of R₃ to R₆ may have a substituent, and R₃ to R₆ may be the same or different.

3. The optical information recording medium according to claim 1, wherein the acid is at least one of an organic acid and an inorganic acid, and the molar ratio of the hydrogen ion (H⁺) in the acid to the mono(aza)methine dye compound is in the range of 0.8 to 3.

4. The optical information recording medium according to claim 2, wherein the acid is at least one of an organic acid and an inorganic acid, and the molar ratio of the hydrogen ion (H⁺) in the acid to the mono(aza)methine dye compound is in the range of 0.8 to 3.

5. The optical information recording medium according to claim 1, wherein the dye film comprises a J-aggregate of the mono(aza)methine compound.

6. The optical information recording medium according to claim 2, wherein the dye film comprises a J-aggregate of the mono(aza)methine compound.

7. The optical information recording medium according to claim 1, wherein the dye film has a peak absorbance at a wavelength of 350 to 500 nm.

8. The optical information recording medium according to claim 2, wherein the dye film has a peak absorbance at a wavelength of 350 to 500 nm.

9. The optical information recording medium according to claim 1, further comprising a layer for transmittance of the laser beam therethrough wherein the dye film is provided on and in contact with a surface of the layer, said surface being opposite to a surface of the layer for the entry of the laser beam.

10. The optical information recording medium according to claim 2, further comprising a layer for transmittance of the laser beam therethrough wherein the dye film is provided on and in contact with a surface of the layer, said surface being opposite to a surface of the layer for the entry of the laser beam.

11. The optical information recording medium according to claim 1, which is an HD DVD-R disc or a Blue-ray Disc-R disc.

12. A method of producing an optical information recording medium including an optical recording layer onto which information is to be recorded by a laser beam, comprising:
applying to a layer for transmittance of the laser beam a solution of a mono(aza)methine dye composition containing a mono(aza)methine dye compound represented by general formula [1] and an acid by a spin-coating method to form the optical recording layer: 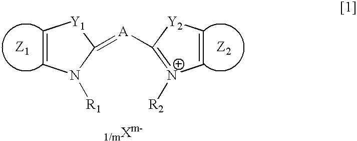
wherein Z₁ and Z₂ each represent an atomic group required for forming a five- or six-membered aromatic ring or a five- or six-membered nitrogen-containing heterocyclic ring, Z₁ and Z₂ may be the same or different, and each of Z₁ and Z₂ may have a substituent; Y₁ and Y₂ each represent one selected from the group consisting of O, S, N—R (wherein R represents an alkyl group of (CH)ₙCH₃, wherein n represents an integer selected from 0 to 5), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; and 1/m X^{m-} (wherein m represents an integer selected from 1 to 4) represents at least one anion selected from the group consisting of an organic anion, an inorganic anion, and an organometallic anion.

13. The method of producing an optical information recording medium according to claim 12, wherein the mono(aza)methine compound represented by general formula [1] is a mono(aza)methine compound represented by general formula [2]: 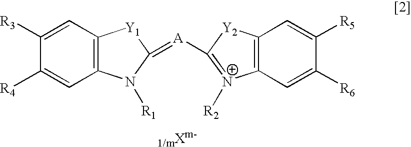
wherein Y₁ and Y₂ each represent one selected from the group consisting of O, S, N—R (wherein R represents an alkyl group of (CH)ₙCH₃, wherein n represents an integer selected from 0 to 5), and CH═CH, and Y₁ and Y₂ may be the same or different; A represents CH or N; R₁ and R₂ each represent an alkyl group of (CH)ₙCH₃ (wherein n represents an integer selected from 0 to 5), and R₁ and R₂ may be the same or different; 1/m X^{m-} (wherein m represents an integer selected from 1 to 4) represents at least one anion selected from the group consisting of an organic anion, an inorganic anion, and an organometallic anion; and R₃ to R₆ each represent one selected from the group consisting of a hydrogen atom, a linear or branched aliphatic hydrocarbon group, a halogenated aliphatic hydrocarbon group, a halogen atom, an ether group, an ester group, an alkylsulfamoyl group, a nitro group, a cyano group, an aromatic ring, and a heterocyclic ring, each of R₃ to R₆ may have a substituent, and R₃ to R₆ may be the same or different.

14. The method of producing an optical information recording medium according to claim 12, wherein in the step of applying the mono(aza)methine dye compound, an amount of the acid added is adjusted so as to form a J-aggregate of the mono(aza)methine dye compound.

15. The method of producing an optical information recording medium according to claim 12, wherein the solution includes a fluorinated alcohol as a solvent for dissolving the mono(aza)methine dye compound.

16. The method of producing an optical information recording medium according to claim 15, wherein the fluorinated alcohol is 2,2,3,3-tetrafluoro-1-propanol.

17. The method of producing an optical information recording medium according to claim 12, wherein the acid is sulfonic acid.

18. The method of producing an optical information recording medium according to claim 12, wherein the solution is applied by spin coating.
